(19) United States
(12) Patent Application Publication
(10) Pub. No.: US 2020/0063590 A1
(43) Pub. Date: Feb. 27, 2020

(54) SEALING MEMBER FOR GAS TURBINE ENGINE

(71) Applicant: General Electric Company, Schenectady, NY (US)

(72) Inventors: Mingchao Wang, West Chester, OH (US); David Sheng, Evendale, OH (US); John Andrew Ravenhall, Hamilton, OH (US); Adam Carlson, West Chester, OH (US); Robert Kaminski, Warsaw (PL); Michal Tomasz Kuropatwa, Warsaw (PL); Nicholas J. Kray, West Chester, OH (US)

(21) Appl. No.: 16/109,663

(22) Filed: Aug. 22, 2018

(51) Int. Cl. F01D 11/00

(52) U.S. Cl. CPC F01D 11/006; F05D 2240/55

(57) ABSTRACT

A sealing member for a gas turbine engine is provided. The sealing member comprises a body portion configured to be positioned between at least a portion of a fan blade of the gas turbine engine and at least a portion of a fan platform disposed between adjacent fan blades for providing seal between the fan blade and the fan platform.

### TECHNICAL FIELD

Embodiments of the present disclosure relate generally to a gas turbine engine, more specifically, to sealing members for the gas turbine engine.

### BACKGROUND

A gas turbine engine generally includes a fan and a core arranged in flow communication with one another. The core of the gas turbine engine generally includes, in serial flow order, a compressor section, a combustion section, a turbine section, and an exhaust section. The fan includes a plurality of circumferentially spaced fan blades extending radially outward from a rotor disk. At least a portion of the air flowing over the fan blades may be provided to the core of the gas turbine engine. During operation of the gas turbine engine, ambient air is channeled between adjacent rotating fan blades and pressurized thereby, which may generate thrust for powering an aircraft in flight. Fan platforms provide a radially inner flowpath boundary for the airflow channel between the plurality of fan blades. The fan platforms are located between adjacent fan blades, near the rotor disk. Fan platforms must have suitable strength for accommodating both centrifugal loads and impact loads during operation. Additionally, fan platforms must provide sufficient seal to prevent airflow leakage. Otherwise, current fan blade, platform and flowpath spacer design have airflow leakage path at a fan blade trailing edge and it is potentially the ice crystal path to the space underneath fan platforms. Accordingly, it would be desirable to provide a better configuration to provide effective seal.

### BRIEF DESCRIPTION

In accordance with some embodiment disclosed herein, a sealing member for a gas turbine engine is provided. The sealing member comprising a body portion configured to engage with at least a portion of a fan blade of the gas turbine engine and at least a portion of a fan platform disposed between adjacent fan blades for providing seal between the fan blades and the fan platform.

In accordance with some other embodiments disclosed herein, a fan of a gas turbine engine is provided. The fan comprises a rotor disk, a plurality of fan blades extending outwardly from the rotor disk, a fan platform disposed between adjacent fan blades of the plurality of fan blades, and a sealing member positioned between a portion of the fan platform and the adjacent fan blades of the plurality of fan blades for providing seal at a trailing edge of the fan blades and as a chordwise periphery.

In accordance with another embodiments disclosed herein, a gas turbine engine is provided. The gas turbine engine comprises a fan section and a core turbine engine disposed downstream from the fan section. The fan section comprises a rotor disk, a plurality of fan blades extending outwardly from the rotor disk, a fan platform disposed between adjacent fan blades of the plurality of ban blades, and a seal member positioned between a portion of the fan platform and the adjacent fan blades of the plurality of fan blades for providing seal therebetween.

### BRIEF DESCRIPTION OF THE DRAWINGS

These and other features and aspects of the present disclosure will become better understood when the following detailed description is read with reference to the accompanying drawings in which like characters represent like parts throughout the drawings, wherein:

FIG. 1 is a schematic cross-sectional view of an exemplary gas turbine engine.

FIG. 2 is a schematic cross-sectional view of a forward end of the exemplary gas turbine engine of FIG. 1.

FIG. 3 is a schematic cross-sectional view along a radial direction of a fan of the exemplary gas turbine engine of FIG. 1.

FIG. 4 is an enlarged cross-sectional view along an axial direction of a fan platform in accordance with an exemplary embodiment of the present disclosure.

FIG. 5 is a schematic view of a sealing member placed between a fan platform and a fan blade in accordance with various embodiments of the present disclosure.

FIG. 6 is a perspective view of the sealing member of FIG. 5.

FIG. 7 is a schematic view of a sealing member contacting with a fan platform and a fan blade in accordance with some embodiments of the present disclosure.

FIG. 8 is a schematic view of a sealing member contacting with a fan platform and a fan blade in accordance with some other embodiments of the present disclosure.

FIG. 9 is a schematic view of a sealing member placed between a fan platform and a fan blade in accordance with various embodiments of the present disclosure.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

Unless defined otherwise, technical and scientific terms used herein have the same meaning as is commonly understood by one of ordinary skill in the art to which this disclosure belongs. As used herein, the terms “a” and “an” do not denote a limitation of quantity, but rather denote the presence of at least one of the referenced items. The use of “including,” “comprising” or “having” and variations thereof herein are meant to encompass the items listed thereafter and equivalents thereof as well as additional items. The terms “axial” and “axially” refer to directions and orientations extending substantially parallel to a longitudinal axis of a gas turbine engine. Moreover, the terms “radial” and “radially” refer to directions and orientations extending substantially perpendicular to the longitudinal axis of the gas turbine engine. In addition, as used herein, the terms “circumferential” and “circumferentially” refer to directions and orientations extending arcuately about the longitudinal axis of the gas turbine engine.

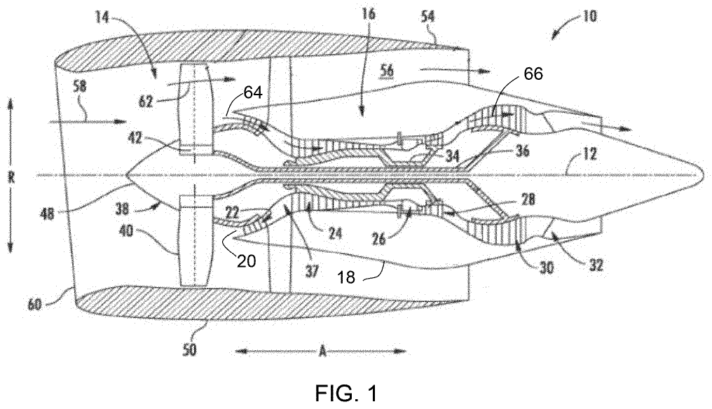

Now, referring to the drawings wherein identical reference numerals denote the same elements throughout the various views, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, referred to herein as “turbofan engine 10.” As shown in FIG. 1, the turbofan engine 10 defines an axial direction A (extending parallel to a longitudinal centerline 12 provided for reference), a radial direction R, and a circumferential direction C. In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 drivingly connects the HP turbine 28 to the HP compressor 24. A low pressure (LP) shaft 36 drivingly connects the LP turbine 30 to the LP compressor 22. The compressor section, combustion section 26, turbine section, and nozzle section 32 together define a core air flowpath 37.

The exemplary fan section 14 includes a fan 38 having a plurality of fan blades 40 coupled to a rotor disk 42 in a spaced apart manner. As depicted, the fan blades 40 extend outwardly from the rotor disk 42 generally along the radial direction R. The disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. A downstream section 54 of the nacelle 50 may extend over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the core air flowpath 37, or more specifically into the LP compressor 22. The pressure of the second portion of the air 64 is then increased as it is routed through the HP compressor 24 and into the combustion section 26, where it is mixed with fuel and burned to provide combustion gases 66.

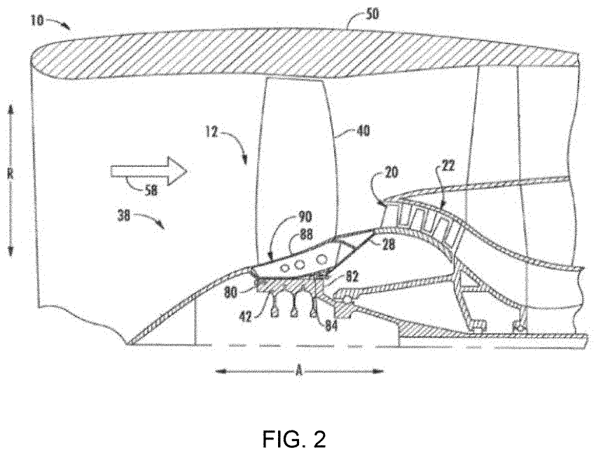

Referring to FIG. 2, a close-up, schematic view is provided of the exemplary turbofan engine 10 of FIG. 1. As shown, the fan 38 includes the rotor disk 42 and the plurality of circumferentially spaced fan blades 40 (only one shown in FIG. 2) extending radially outwardly from the rotor disk 42. The turbofan engine 10 additionally includes a plurality of discrete platforms 88 that are provided between each pair of adjacent fan blades 40 of the plurality of fan blades 40. Specifically, each platform 88 is disposed between a respective pair of adjacent fan blades 40 and radially outward from the rotor disk 42. Each of the platforms 88 has a radially outer surface 90 extending between the respective adjacent fan blades 40 so as to collectively define an inner flowpath boundary for channeling air 58 between the fan blades 40.

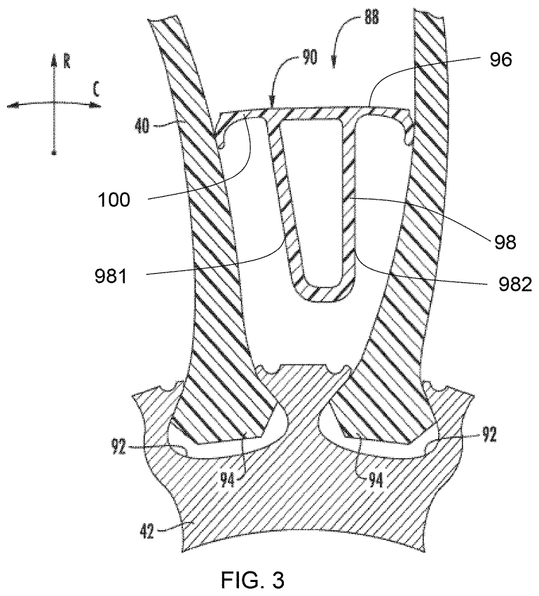

Referring to FIG. 3, a simplified, cross-sectional view of a pair of adjacent fan blades 40, a corresponding portion of the rotor disk 42, and a fan platform 88 are depicted schematically. As shown, the rotor disk 42 includes a plurality of circumferentially spaced apart axial dovetail slots 92 which extend radially inwardly from the disk outer surface 84, with the disk portions between the dovetails slots 92. Each of the fan blades 40 includes an integral root section 94 that is in the form of a complementary axial-entry dovetail. The dovetail root sections 94 are disposed in respective ones of the dovetail slots 92 for attaching the fan blades 40 to the rotor disk 42. The dovetail slots 92 and root sections 94 are designed so as to permit limited rotation of the root section 94 along the circumferential direction C, about the axial direction A, within the dovetail slot 92 in response to, e.g., an extreme force exerted on the fan blade 40.

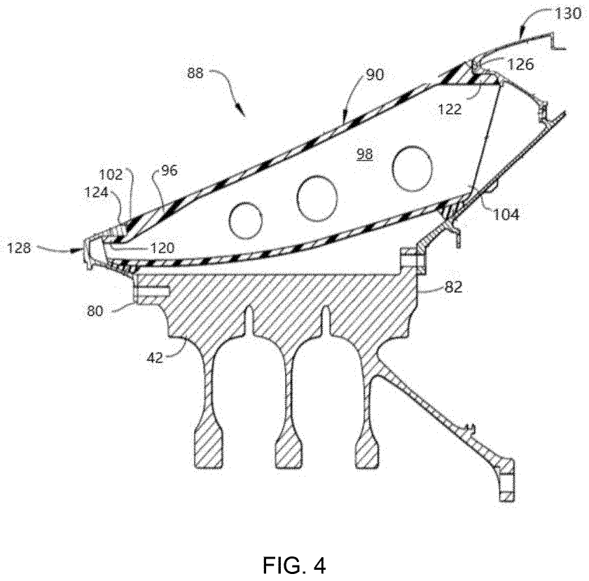

The platform 88 generally includes a structural body portion 98 and a flowpath surface portion 96 which are joined in a substantially T-shaped configuration in cross-section. As shown in FIG. 4, the platform 88 has a forward end 102 disposed near the disk forward side 80, and an axially opposite aft end 104 disposed near the disk aft side 82. The body portion 98 contributes to the bulk of the platform's 88 mass and consequently may provide the platform 88 with an amount of strength necessary to carry its centrifugal load.

The platform 88 is retained by a forward support ring 128 at a forward portion 120 of the platform 88 and an aft support ring 130 at an aft portion 122 of the platform 88. The forward support ring 128 comprises a forward retaining wall 124 coupling with the forward portion 120 of the platform 88 and the aft support ring 130 comprises an aft retaining wall 126 coupling with the aft portion 122 of the platform 88. Moreover, the forward support ring 128 is an annular member that is substantially C-shaped in cross-section and retains the forward end 102 of the platform 88 against radially outward movement and forward axial movement due to centrifugal force upon rotation of the rotor disk 42 during engine operation. The aft supporting ring 130 is an annular member that is substantially V-shaped in cross-section and retains the aft end 104 of the platform 88 against radially outward movement and axial movement due to centrifugal force upon rotation of the rotor disk 42 during engine operation.

Referring again to FIG. 3, the flowpath surface portion 96 extends laterally beyond each side wall 981, 982 of the structural body portion 98 to define a pair of wings 100. The wings 100 extend blade-to-blade so as to completely fill the space between adjacent blades 40. The outer lateral edges of the wings are provided with a curved contour that matches the contour of the corresponding adjacent fan blade.

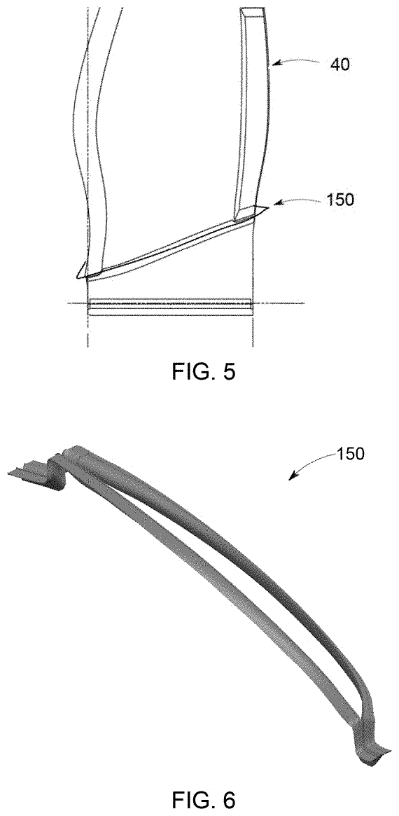

Referring to FIGS. 5, 6, 7 and 8, a sealing member placed between a fan platform and a fan blade to provide seal therebetween and as a chordwise periphery is illustrated in accordance with various embodiments of the present disclosure. Specifically, as shown in FIG. 5, in some embodiments, a sealing member 150 is positioned to engage with at least a portion of the wings 100 of the fan platform 88 and the adjacent fan blades 40. In some embodiments, the sealing member 150 may be free-floating between the fan blades 40 and the fan platform 88, i.e., not bonded or mechanically connected to either the fan blades 40 or the fan platform 88. As further shown in FIG. 6, the body portion of the sealing member 150 can be annular (e.g., full hoop) so as to surround the adjacent fan blades 40 in the circumferential direction. In some embodiments, the sealing member 150 may be molded as circular or connected as circular after assembly, which is easier for replacement as needed. The cross section of the sealing member 150 may be different geometry through different locations between the fan blades 40 and the fan blades 40.

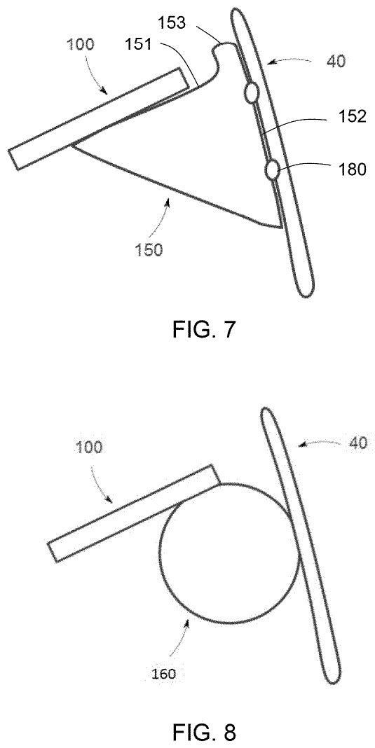

Referring now particularly to FIG. 7, in some embodiments, the sealing member 150 has a substantially triangle cross-sectional shape. The sealing member 150 as illustrated includes two adjacent edges 151, 152 which are respectively attached to at least a portion of the wing 100 and the adjacent fan blade 40. The two edges 151, 152 can tightly abuts on the both surfaces of the wing 100 and the adjacent fan blade 40 under centrifugal load during operation of the fan. The sealing member 150 further includes a protrusion 153 extending from the two adjacent edges 151, 152 and positioned at an interface between the wing 100 and the adjacent fan blade 40 so as to ensure sufficient seal therebetween. In such embodiments, at least one supporting member 180 is provided between the sealing member 150 and the adjacent fan blade 40 that the seal member 150 is attached to so as to keep the sealing member 150 always be attached to the fan blade 40 with or without centrifugal load.

Referring now particularly to FIG. 8, in some other embodiments, a sealing member 160 has a substantially circular cross-sectional shape. The sealing member 160 may also be tightly abut on the both surfaces of the wing 100 and the adjacent fan blade 40 under centrifugal load during operation of the fan. Otherwise, it allows the sealing member to be away from the fan blade 40 without centrifugal load.

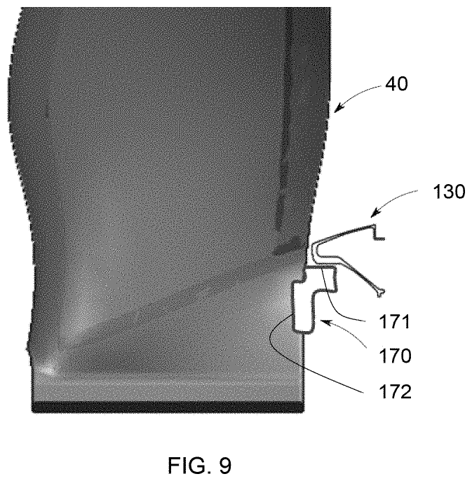

Referring to FIG. 9, a sealing member placed between a fan platform and an adjacent fan blade is illustrated in accordance with another embodiments of the present disclosure. The sealing member 170 as shown is positioned between a portion of the aft end 104 (shown in FIG. 4) of the platform 88 and the adjacent fan blade 40 for providing sealing at a trailing edge of the fan blades and as a chordwise periphery. Furthermore, the sealing member 170 is attached to both of the aft supporting ring 130 extending axially outward from the aft end 104 and the adjacent fan blade 40. The sealing member 170 is shaped to accommodate the aft supporting ring 130 and the fan blade 40 where each engaged with. Specifically, the sealing member 170 includes a first surface 171 and a second surface 172. As illustrated, the first surface 171 radially outward-facing abuts to the aft supporting ring 130, and the second surface 172 axially outward-facing attaches to, e.g., bonds to, the fan blade 40. In some embodiments, the seal member 170 may be made with elastic material, e.g., may be a rubber tab. During operation, the rubber tab is flexible to accommodate fan blades and platform relative movement.

Exemplary embodiments of systems and/or methods for sealing members are described above in detail. The methods and systems are not limited to the specific embodiments described herein, but rather, components of systems and/or steps of the methods may be utilized independently and separately from other components and/or steps described herein. For example, the sealing members may also be used in combination with other applications, and are not limited to practice only with the gas turbine engine as described herein. Rather, the exemplary embodiments can be implemented and utilized in connection with many other apparatus.

While the disclosure has been described with reference to exemplary embodiments, it will be understood by those skilled in the art that various changes may be made and equivalents may be substituted for elements thereof without departing from the scope of the disclosure. Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional assemblies and techniques in accordance with principles of this disclosure. In addition, many modifications may be made to adapt a particular situation or material to the teachings of the invention without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A sealing member for a gas turbine engine, the sealing member comprising:
a body portion configured to be positioned between at least a portion of a fan blade of the gas turbine engine and at least a portion of a fan platform disposed between adjacent fan blades for providing seal between the fan blade and the fan platform.

2. The sealing member of claim 1, wherein the sealing member comprises a polygonal cross-sectional shape with at least two adjacent edges which are respectively attached to at least a portion of the fan platform and the adjacent fan blades.

3. The sealing member of claim 2, wherein the sealing member has a triangle cross-sectional shape.

4. The sealing member of claim 2, wherein at least one supporting member is provided between the sealing member and the adjacent fan blades that the sealing member is attached to.

5. The sealing member of claim 2, wherein the sealing member comprises a protrusion extending from the two adjacent edges and positioned between the fan platform and the adjacent fan blades.

6. The sealing member of claim 1, wherein the sealing member has a circular cross-sectional shape.

7. The sealing member of claim 1, wherein the sealing member is free-floating between the fan platform and the fan blades.

8. A fan of a gas turbine engine, the fan comprising:
a rotor disk;
a plurality of fan blades extending outwardly from the rotor disk;
a fan platform disposed between adjacent fan blades of the plurality of fan blades; and
a sealing member positioned between a portion of the fan platform and the adjacent fan blades of the plurality of fan blades for providing seal at a trailing edge of the fan blades and as a chordwise periphery.

9. The fan of claim 8, wherein the sealing member is shaped to accommodate a trailing edge of the platform and attached to the platform trailing edge.

10. The fan of claim 8, wherein the sealing member is shaped to accommodate the adjacent fan blades and attached to the adjacent fan blades.

11. The fan of claim 8, wherein the sealing member is made with elastic material.

12. The fan of claim 8, wherein the sealing member includes a first surface and a second surface engaging respectively with at least a portion of the fan platform and the adjacent fan blades, the first surface radially outward-facing abutting to an aft supporting ring retaining the fan platform, and the second surface axially outward-facing attaching to the fan blade.

13. A gas turbine engine comprising:
a fan section; and
a core turbine engine disposed downstream from the fan section;
the fan section comprising:
a rotor disk;
a plurality of fan blades extending outwardly from the rotor disk;
a fan platform disposed between adjacent fan blades of the plurality of ban blades: and
a seal member positioned between a portion of the fan platform and the adjacent fan blades of the plurality of fan blades for providing seal therebetween.

14. The gas turbine engine of claim 13, wherein the sealing member comprises a polygonal cross-sectional shape with at least two edges which are respectively contact with at least a portion of the fan platform and the adjacent fan blades.

15. The gas turbine engine of claim 14, wherein the sealing member comprises a protrusion extending from two adjacent edges of the at least two edges and positioned between the platform and the adjacent fan blades.

16. The gas turbine engine of claim 14, wherein at least one supporting member is provided between the sealing member and the adjacent fan blades that the sealing member is attached to.

17. The gas turbine engine of claim 13, wherein the sealing member has a triangle cross-sectional shape.

18. The gas turbine engine of claim 13. wherein the sealing member has a circular cross-sectional shape.

19. The gas turbine engine of claim 13, wherein the sealing member is free-floating between the fan platform and the fan blades.

20. The gas turbine engine of claim 13, wherein the fan platform comprises:
a structural body portion having a contour that matches that of the adjacent fan blades; and
a flowpath surface portion attached to the structural body portion and at least partially defining a flowpath boundary of the fan, a pair of wings extending laterally beyond the structural body portion; and wherein
the sealing member engaged with at least a portion of the wings and the adjacent fan blades, surrounding the adjacent fan blades for providing seal therebetween.
